(19) United States
(12) Patent Application Publication
(10) Pub. No.: US 2026/0106340 A1
(43) Pub. Date: Apr. 16, 2026

(54) ELECTRODE FOR SECONDARY BATTERY AND SECONDARY BATTERY INCLUDING THE ELECTRODE

(71) Applicant: SAMSUNG SDI CO., LTD., Yongin-si (KR)

(72) Inventor: Iloh SON, Yongin-si (KR)

(21) Appl. No.: 19/087,785

(22) Filed: Mar. 24, 2025

(30) Foreign Application Priority Data
Oct. 10, 2024 (KR) 10-2024-0137778

(51) Int. Cl. H01M 50/533

(52) U.S. Cl. CPC H01M 50/533

(57) ABSTRACT

An electrode for a secondary battery includes a substrate including a conductive metal material, a non-coated portion where the substrate is exposed, coated portions where an active material layer is provided, and an electrode tab coupled to the non-coated portion. The electrode tab includes a protrusion protruding in a first direction from a side of the non-coated portion, and a notched portion including a plurality of tabs connected to the non-coated portion and spaced apart from each other in a second direction that is different from the first direction.

### CROSS-REFERENCE TO RELATED APPLICATION

The present application claims priority to and the benefit of Korean Application No. 10-2024-0137778, filed on Oct. 10, 2024, in the Korean Intellectual Property Office, the entire disclosure of which is incorporated by reference herein.

### BACKGROUND

### Field

The present disclosure relates to an electrode for a secondary battery and a secondary battery including the electrode.

### Description of Related Art

Unlike primary batteries that are not designed to be (re)charged, secondary (or rechargeable) batteries are batteries that are designed to be discharged and recharged. Low-capacity secondary batteries are used in portable, small electronic devices, such as smart phones, feature phones, notebook computers, digital cameras, and camcorders, while large-capacity secondary batteries are widely used as power sources for driving motors in hybrid vehicles and electric vehicles and for storing power (e.g., home and/or utility scale power storage). A secondary battery generally includes an electrode assembly composed of a positive electrode and a negative electrode, a case accommodating the same, and electrode terminals connected to the electrode assembly.

Typically, the electrodes of a secondary battery include electrode tabs for electrical connection to external terminals. As a result, the thickness of the electrodes may vary, which may cause cracks in the electrode during the initial charge/discharge processes. In addition, secondary batteries may experience rapid temperature rises due to various events such as short-circuiting of electric circuits or application of high currents depending on the use. These abnormalities may affect the intrinsic characteristics of secondary batteries, resulting in performance degradation and increase the risk a thermal runaway event that can cause a fire.

The above information disclosed in this Background section is for enhancement of understanding of the background of the present disclosure, and therefore, it may contain information that does not constitute related (or prior) art.

### SUMMARY

The present disclosure provides an electrode for a secondary battery including an electrode tab that is resistant to cracks caused by expansion of the electrode and has lower short-circuit temperature, and a secondary battery including the electrode.

These and other aspects and features of the present disclosure will be described in or will be apparent from the following description of embodiments of the present disclosure.

However, aspects and features of the present disclosure are not limited to those described above, and other aspects and features not mentioned will be clearly understood by a person skilled in the art from the detailed description, described below.

According to some embodiments of the present disclosure, an electrode for a secondary battery may include a substrate including a conductive metal material, a non-coated portion where the substrate is exposed, a coated portion at ends of the substrate where an active material layer is provided, and an electrode tab configured coupled to the non-coated portion. The electrode tab may include a protrusion protruding in a first direction from a side of the non-coated portion, and a notched portion including a plurality tabs connected to the non-coated portion and spaced apart from each other in a second direction that is different from the first direction.

According to some embodiments of the present disclosure, the notched portion may be spaced apart from ends of the non-coated portion by gaps in the second direction.

According to some embodiments of the present disclosure, the notched portion may be spaced apart from a side of the non-coated portion in the first direction by a gap.

According to some embodiments of the present disclosure, the notched portion may be spaced apart from a side of the non-coated portion by a first gap in the first direction, the notched portion may be spaced apart from ends of the non-coated portion by a second gap in the second direction, and the first gap may be less than the second gap.

According to some embodiments of the present disclosure, a gap between adjacent tabs among the plurality of tabs may be greater than a length of each of the tabs in the second direction.

According to some embodiments of the present disclosure, each of the tabs may have a length in the first direction that is less than half of a length of the non-coated portion in the first direction.

According to some embodiments of the present disclosure, each of the tabs may extend in the first direction.

According to some embodiments of the present disclosure, the protrusion may be disposed at a central portion of the notched portion along the second direction.

According to some embodiments of the present disclosure, an end of at least one of the tabs may include a circular shape.

According to some embodiments of the present disclosure, at least one hole extends through the protrusion, with the hole being spaced apart from the non-coated portion.

According to some embodiments of the present disclosure, a secondary battery may include an electrode assembly comprising a first electrode, a second electrode, and a separator disposed between the first electrode and the second electrode, a case comprising a bottom portion electrically connected to the second electrode, a side wall portion connected to the bottom portion, and an opening on an upper side facing the bottom portion, with the case accommodating the electrode assembly, and a cap assembly coupled to the case to close the opening. The first electrode may include a substrate configured to include a conductive metal material, a non-coated portion where the substrate is exposed, coated portions at ends of the substrate where an active material layer is provided, and an electrode tab coupled to the non-coated portion. Herein, the electrode tab may include a protrusion protruding in a first direction from a side of the non-coated portion, and a notched portion including a plurality of tabs connected to the non-coated portion and spaced apart from each other in a second direction that is different from the first direction.

According to embodiments of the present disclosure, it is possible to prevent cracks in the electrode that may occur during charging/discharging processes by including an electrode tab that minimizes thickness variation of the electrode.

According to embodiments of the present disclosure, an electrode tab may be more easily break when a specific event occurs because the electrode tab has high resistance at a portion where the electrode tab is electrically connected to an outside structure. Thus, side reactions and thermal runaway caused by overcurrent inside the secondary battery may be prevented.

However, aspects and features of the present disclosure are not limited to those described above, and other aspects and features not mentioned will be clearly understood by a person skilled in the art from the detailed description, described below.

### BRIEF DESCRIPTION OF THE DRAWINGS

The following drawings attached to this specification illustrate embodiments of the present disclosure, and further describe aspects and features of the present disclosure together with the detailed description of the present disclosure. Thus, the present disclosure should not be construed as being limited to the drawings:

FIG. 1 is a view of a secondary battery according to embodiments of the present disclosure.

FIG. 2 is a view of a cap assembly of a secondary battery according to embodiments of the present disclosure.

FIG. 3 is a view of an electrode for a secondary battery according to embodiments of the present disclosure.

FIG. 4 is a view of an electrode for a secondary battery according to embodiments of the present disclosure.

FIG. 5 is a view of an electrode for a secondary battery according to embodiments of the present disclosure.

FIG. 6 is a view of an electrode for a secondary battery according to embodiments of the present disclosure.

FIG. 7 is a view of an electrode for a secondary battery according to embodiments of the present disclosure.

FIG. 8 is a view of a mechanism by which an electrode tab of a secondary battery electrode ruptures at low temperatures.

FIG. 9 is an exploded perspective view of a secondary battery including an electrode for a secondary battery according to an embodiment of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components but do not preclude the presence or addition of one or more other features, integers, steps, operations, elements, components, and/or groups thereof.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” when describing embodiments of the present disclosure relates to “one or more embodiments of the present disclosure.” Expressions, such as “at least one of” and “any one of,” when preceding a list of elements, modify the entire list of elements and do not modify the individual elements of the list. When phrases such as “at least one of A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

References to two compared elements, features, etc. as being “the same” may mean that they are “substantially the same”. Thus, the phrase “substantially the same” may include a case having a deviation that is considered low in the art, for example, a deviation of 5% or less. In addition, when a certain parameter is referred to as being uniform in a given region, it may mean that it is uniform in terms of an average.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Throughout the specification, unless otherwise stated, each element may be singular or plural.

Arranging an arbitrary element “above (or below)” or “on (under)” another element may mean that the arbitrary element may be disposed in contact with the upper (or lower) surface of the element, and another element may also be interposed between the element and the arbitrary element disposed on (or under) the element.

It will be understood that when an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, when a first element is described as being “coupled” or “connected” to a second element, the first element may be directly coupled or connected to the second element or the first element may be indirectly coupled or connected to the second element via one or more intervening elements. In addition, it will be understood that when a component is referred to as being “linked,” “coupled,” or “connected” to another component, the elements may be directly “coupled,” “linked” or “connected” to each other, or another component may be “interposed” between the components”.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

Throughout the specification, when “A and/or B” is stated, it means A, B or A and B, unless otherwise stated. That is, “and/or” includes any or all combinations of a plurality of items enumerated. When “C to D” is stated, it means C or more and D or less, unless otherwise specified.

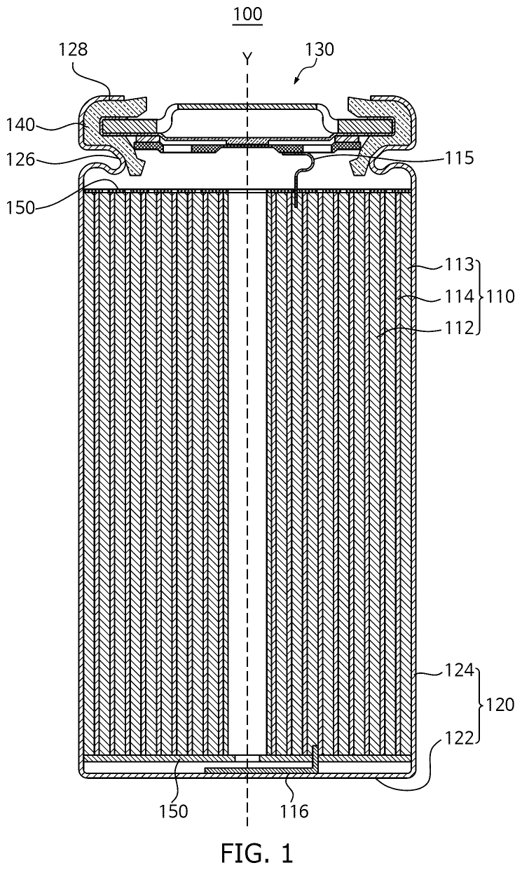

FIG. 1 is a view showing a secondary battery 100 according to embodiments of the present disclosure. Referring to FIG. 1, a secondary battery 100 includes an electrode assembly 110 and a case 120 that accommodates the electrode assembly 110 and an electrolyte solution therein. A cap assembly 130 is coupled to an opening of the case 120 to seal the case 120. An insulating plate 150 is disposed between the electrode assembly 110 and the cap assembly inside the case 120.

The electrode assembly 110 may include a first electrode 112 and a second electrode 113 with a separator 114 positioned between the electrodes 112 and 113. The electrode assembly 110 may be wound on the winding axis Y into a jelly-roll shape.

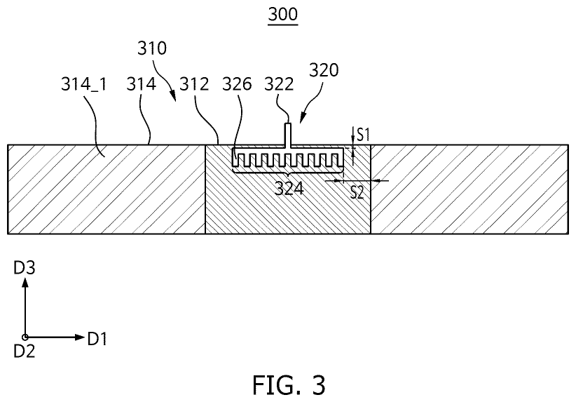

The first electrode 112 includes a first substrate and a first active material layer disposed on the first substrate. The first electrode 112 also includes a first non-coated portion where the first active material layer is not provided on the first substrate, and a first electrode tab 115 extends from an end of the first non-coated portion. The first electrode tab 115 may be electrically connected to a cap assembly 130. The first electrode 112 or the first electrode tab 115 may include at least a part of any one of the electrodes for secondary batteries according to the embodiments described below with reference to FIGS. 3 to 6 of the present disclosure.

The second electrode 113 includes a second substrate and a second active material layer disposed on the second substrate. The second electrode 113 also includes a second non-coated portion where the second active material layer is not provided on the second substrate, and a second electrode tab 116 extends from an end of the second non-coated portion. The second electrode tab 116 may be electrically connected to the case 120. The first electrode tab 115 and the second electrode tab 116 may extend in opposite directions.

The first electrode 112 may function as a positive electrode. In such a case, the first substrate may be formed from, for example, aluminum foil, and the first active material layer may include, for example, a transition metal oxide. The second electrode 113 may function as a negative electrode. In such a case, the second substrate may be formed from, for example, copper foil or nickel foil, and the second active material layer may include, for example, graphite.

The separator 114 functions to prevent short circuits between the first electrode 112 and the second electrode 113 while allowing the movement of lithium ions between the electrodes 112 and 113. The separator 114 may be formed from, for example, a polyethylene film, a polypropylene film, a polyethylene-polypropylene film, etc.

The case 120 and the cap assembly 130 may form the outer shape of the secondary battery 100. The case 120 may include a side wall portion 124 having a roughly cylindrical shape, and a bottom portion 122 at an end of the side wall portion 124. A beading portion 126 deformed toward the inside of the battery may be formed on the side wall portion 124, and a clamping portion 128 bent toward the inside of the battery may be formed on the open end of the side wall portion 124.

The beading portion 126 may prevent the electrode assembly 110 from moving inside the case 120 and facilitate the fixing of the gasket 140 and the cap assembly 130. The clamping portion 128 may firmly fix the cap assembly 130 by pressing the edge of the cap assembly 130 through the gasket 140. The case 120 may be made of, for example, nickel-plated iron.

The insulating plate 150 may be disposed in contact with the electrode assembly 110 below the beading portion 126, and a tab opening through which the first electrode tab 115 extends may be provided in the insulating plate 150. The cap assembly 130, which is electrically connected to the first electrode 112 by the first electrode tab 115, faces the electrode assembly 110 with the insulating plate 150 interposed therebetween. Thus, the cap assembly 130 is insulated from the electrode assembly 110 by the insulating plate 150.

In an embodiment, the positive electrode corresponding to the first electrode 112 of the secondary battery 100 may include a current collector and a positive electrode active material layer formed on the current collector. The positive electrode active material layer may include a positive electrode active material and may further include a binder and/or a conductive material (e.g., an electrically conductive material).

The positive electrode active material may include a compound (lithiated intercalation compound) that is capable of intercalating and deintercalating lithium. Specifically, at least one of a composite oxide of lithium and a metal selected from cobalt, manganese, nickel, and combinations thereof may be used.

The composite oxide may be a lithium transition metal composite oxide. Specific examples of the composite oxide may include lithium nickel-based oxide, lithium cobalt-based oxide, lithium manganese-based oxide, lithium iron phosphate-based compound, cobalt-free nickel-manganese-based oxide, or a combination thereof.

As an example, the following compounds represented by any one of the following Chemical Formulas may be used. LiaA1−bXbO2−cDc (0.90≤a≤1.8, 0≤b≤0.5, and 0≤c≤0.05); LiaMn2−bXbO4−cDc (0.90≤a≤1.8, 0≤b≤0.5, and 0≤c≤0.05); LiaNi1−b−cCobXcO2−αDα (0.90≤a≤1.8, 0≤b≤0.5, 0≤c≤0.5, and 0<α<2); LiaNi1−b−cMnbXcO2−αDα (0.90≤a≤1.8, 0≤b≤0.5, 0≤c≤0.5, and 0<α<2); LiaNibCocL1dGeO2 (0.90≤a≤1.8, 0≤b≤0.9, 0≤c≤0.5, 0≤d≤0.5, and 0≤e≤0.1); LiaNiGbO2 (0.90≤a≤1.8 and 0.001≤b≤0.1); LiaCoGbO2 (0.90≤a≤1.8 and 0.001≤b≤0.1); LiaMn1−bGbO2 (0.90≤a≤1.8 and 0.001≤b≤0.1); LiaMn2GbO4 (0.90≤a≤1.8 and 0.001≤b≤0.1); LiaMn1−gGgPO4 (0.90≤a≤1.8 and 0≤g≤0.5); Li(3−f)Fe2(PO4)3 (0≤f≤2); or LiaFePO4 (0.90≤a≤1.8).

In the above Chemical Formulas, A is Ni, Co, Mn, or a combination thereof; X is Al, Ni, Co, Mn, Cr, Fe, Mg, Sr, V, a rare earth element or a combination thereof; D is O, F, S, P, or a combination thereof; G is Al, Cr, Mn, Fe, Mg, La, Ce, Sr, V, or a combination thereof; and L1 is Mn, Al, or a combination thereof.

The positive electrode active material may be, for example, a high nickel-based positive electrode active material having a nickel content of greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel-based positive electrode active material may be capable of realizing high capacity and can be applied to a high-capacity, high-density rechargeable lithium battery.

The positive electrode may further include an additive that can serve as a sacrificial positive electrode.

An amount of the positive electrode active material may be about 90 wt % to about 99.5 wt % based on 100 wt % of the positive electrode active material layer. Amounts of the binder and the conductive material may be about 0.5 wt % to about 5 wt %, respectively, based on 100 wt % of the positive electrode active material layer. Amounts of the binder and the conductive material may be about 0.5 wt % to about 5 wt %, respectively, based on 100 wt % of the positive electrode active material layer.

The binder serves to attach the positive electrode active material particles well to each other and also to attach the positive electrode active material well to the current collector. Examples of the binder may include polyvinyl alcohol, carboxymethyl cellulose, hydroxypropyl cellulose, diacetyl cellulose, polyvinylchloride, carboxylated polyvinylchloride, polyvinylfluoride, a polymer including ethylene oxide, polyvinylpyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, nylon, and the like, as non-limiting examples.

The conductive material may be used to impart conductivity (e.g., electrical conductivity) to the electrode. Any material that does not cause chemical change (e.g., does not cause an undesirable chemical change in the rechargeable lithium battery) and conducts electrons can be used in the battery. Examples of the conductive material may include a carbon-based material such as natural graphite, artificial graphite, carbon black, acetylene black, ketjen black, a carbon fiber, a carbon nanofiber, and carbon nanotube; a metal-based material containing copper, nickel, aluminum, silver, etc., in a form of a metal powder or a metal fiber; a conductive polymer such as a polyphenylene derivative; or a mixture thereof.

Al may be used as the current collector but is not limited thereto.

The negative electrode corresponding to the second electrode 113 of the secondary battery 100 includes a current collector and a negative electrode active material layer disposed on the current collector. The negative electrode active material layer may include a negative electrode active material and may further include a binder and/or a conductive material (e.g., an electrically conductive material).

The negative electrode active material may include a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, such as, for example. crystalline carbon, amorphous carbon or a combination thereof. The crystalline carbon may be graphite such as non-shaped, sheet-shaped, flake-shaped, sphere-shaped, or fiber-shaped natural graphite or artificial graphite. The amorphous carbon may be a soft carbon, a hard carbon, a mesophase pitch carbonization product, calcined coke, and the like.

The lithium metal alloy includes an alloy of lithium and a metal selected from Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may include silicon, a silicon-carbon composite, SiOx (0<x<2), a Si—Q alloy (where Q is selected from an alkali metal, an alkaline-earth metal, a Group 13 element, a Group 14 element (excluding Si), a Group 15 element, a Group 16 element, a transition metal, a rare earth element, and a combination thereof). The Sn-based negative electrode active material may include Sn, SnO2, a Sn-based alloy, or a combination thereof.

The silicon-carbon composite may be a composite of silicon and amorphous carbon. According to an embodiment, the silicon-carbon composite may be in a form of silicon particles and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

For example, the negative electrode active material layer may include about 90 wt % to about 99 wt % of the negative electrode active material, about 0.5 wt % to about 5 wt % of the binder, and about 0 wt % to about 5 wt % of the conductive material.

The binder may serve to attach the negative electrode active material particles well to each other and also to attach the negative electrode active material well to the current collector. The binder may include a non-aqueous binder, an aqueous binder, a dry binder, or a combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, or a combination thereof.

The aqueous binder may be selected from a styrene-butadiene rubber, a (meth)acrylated styrene-butadiene rubber, a (meth)acrylonitrile-butadiene rubber, (meth)acrylic rubber, a butyl rubber, a fluoro rubber, polyethylene oxide, polyvinylpyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resins, polyvinyl alcohol, and a combination thereof.

When an aqueous binder is used as the negative electrode binder, a cellulose-based compound capable of imparting viscosity may be further included. The cellulose-based compound may include at least one of carboxymethyl cellulose, hydroxypropylmethyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, or a combination thereof.

The conductive material may be used to impart conductivity (e.g., electrical conductivity) to the electrode. Any material that does not cause chemical change (e.g., does not cause an undesirable chemical change in the rechargeable lithium battery) and that conducts electrons can be used in the battery. Non-limiting examples thereof may include a carbon-based material such as natural graphite, artificial graphite, carbon black, acetylene black, ketjen black, a carbon fiber, a carbon nanofiber, and a carbon nanotube; a metal-based material including copper, nickel, aluminum, silver, etc. in a form of a metal powder or a metal fiber; a conductive polymer such as a polyphenylene derivative; or a mixture thereof.

The negative current collector may include a copper foil, a nickel foil, a stainless steel foil, a titanium foil, a nickel foam, a copper foam, a polymer substrate coated with a conductive metal, or a combination thereof.

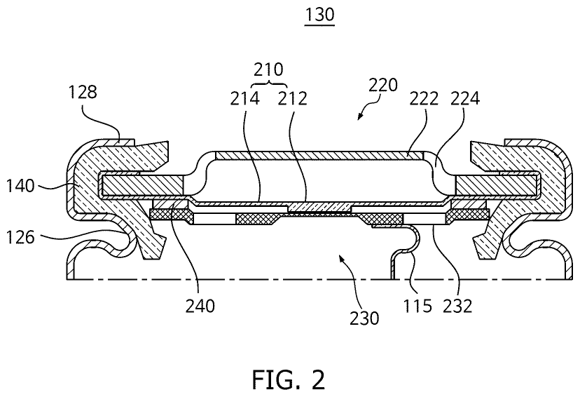

FIG. 2 is a view of a cap assembly 130 of a secondary battery 100 according to embodiments of the present disclosure. The cap assembly 130 may include a vent 210, an upper cap 220, a lower cap 230, a beading portion 126, a gasket 140, and a communication hole 232.

In one embodiment, the vent 210 may be disposed on the upper side of the lower cap 230. The vent 210 may be insulated from the lower cap 230 by an insulating layer 240 disposed on the outer upper surface of the lower cap 230. The vent 210 may surround an area of the outer upper surface and the outer side surface of the lower cap 220.

In an embodiment, the vent 210 includes a protrusion 212 and a rupture portion 214. The protrusion 212 may be formed to protrude downward from the center of the vent 210. The protrusion 212 may be electrically connected to the first electrode 112 through the first electrode tab 115. The rupture portion 214 may be configured to rupture by the pressure of gas discharged through the plurality of communication holes 232. The rupture portion 214 may be formed with a thickness that will rupture when the pressure of the gas reaches a certain level. The rupture portion 214 may be formed to have a thin thickness so that it may be ruptured by pressure of the gas. The rupture portion 214 may be spaced apart from each communication hole 232 or may be offset from each communication hole 232. When the rupture portion 214 ruptures, the protrusion 212 separates from the lower cap 230. The vent 210 may be formed with a step so that it may be easily separated from the lower cap 230.

According to an embodiment, the clamping portion 128 may surround the outer surface and an area of the outer upper surface of the upper cap 220. For example, the clamping portion 128 may be formed using a crimping jig after the upper cap 220 is disposed on the vent 210. The upper cap 220 may be fixed to the vent 210 by the clamping portion 128.

In an embodiment, a plurality of welds (not shown) may be formed on the clamping portion 128. The plurality of welds may be formed symmetrically with respect to a center of the vent 210, but the present disclosure is not limited to this example. Each weld may be formed at a regular space from adjacent welds, but the present disclosure is not limited to this example. Welding may be performed at each of the plurality of welds so that a welding mark (not shown) may be formed in the area where the outer upper surface of the upper cap 220 contacts the vent 210.

In an embodiment, the lower cap 230 may be disposed on the lower side of the vent 210. The lower cap 230 may be formed with a step according to the shape of the vent 210. An insulating layer 240 may be disposed on an area of the upper surface of the outer side of the lower cap down 230 to be insulated from the vent 210. An area of the lower surface on the external side of the lower cap 230 may contact the gasket 140.

According to an embodiment, the lower cap 230 may have the protrusion 212 of the vent 210 disposed at the center of the lower cap 230. The lower cap 230 may include a plurality of communication holes 232 in the central portion of the lower cap 230. The lower cap 230 and vent 210 may be electrically connected to the first electrode 112 through the first electrode tab 115.

The communication holes 232 may be formed spaced apart from each other in the central portion of the lower cap 230. Gases formed inside the secondary battery 100 may be discharged through the communication holes 232. A rupture portion 214 of a vent 210 may be disposed on each communication hole 232. Alternatively, the rupture portion 214 of the vent 210 may be disposed separately from the communication holes 232. During the charging and discharging process of a secondary battery 100, the electrolyte solution may decompose and form gas. The gas may be discharged through a plurality of communication holes 232 formed in the lower cap 230. The rupture portion 214 of the vent 210 may be ruptured by the pressure from the gas being discharged through the communication hole 232.

The lower cap 220 may be disposed above the vent 210. An area of the outer upper surface of the lower cap 220 may be surrounded by and fixed to the vent 210. The lower cap 220 may protrude upward and have a step. The lower cap 220 may protrude upward and be spaced apart from the vent 210. When the vent 210 ruptures, the protrusion 212 of the vent 210 may be separated from the lower cap 230 and the upper cap 220.

The upper cap 220 may include a terminal portion 222 and a plurality of discharge holes 224. The terminal portion 222 may be connected to an external terminal. The lower cap 220 may be electrically connected to the first electrode 112 through the first electrode tab 115, the lower cap 230, and the vent 210. The lower cap 220 may function as a first electrode 112, and the terminal portion 222 may be connected to an external terminal.

The plurality of discharge holes 224 may discharge gas transmitted through the rupture portion 214 of the vent 210. As described above, the rupture portion 214 of the vent 210 may be ruptured by gas pressure, and then the plurality of discharge holes 224 may discharge gas from the battery.

An insulating layer 240 may be disposed between the lower cap 230 and the vent 210. An insulating layer 240 may be disposed on the outer upper surface of the lower cap 230 so that the vent 210 does not contact the lower cap 230 and so that the vent 210 and the lower cap down 230 are insulated from each other. The lower cap 230 and vent 210 may be electrically connected to the first electrode 112 through the first electrode tab 115. The first electrode 112 or the first electrode tab 115 may include at least a part of any one of the electrodes for secondary batteries according to the embodiments disclosed with respect to FIGS. 3 to 6 below.

A gasket 140 surrounds the cap assembly 130 and may be disposed between the case 120 and the cap assembly 130. For example, a ring-shaped gasket 140 may be disposed on one side of the case 120. The gasket 140 may electrically insulate the cap assembly 130 connected to the first electrode 112 and the case 120 connected to the second electrode 113. The gasket 140 may also protect the cap assembly 130 by providing a cushioning effect from external impacts.

FIG. 3 is a view of an electrode 300 for a secondary battery according to embodiments of the present disclosure. The electrode 300 for a secondary battery, that is illustrated in FIG. 3, may have the same or similar configuration as the first electrode 112 or second electrode 113 illustrated in FIG. 1. Referring to FIG. 3, an electrode 300 for a secondary battery according to embodiments of the present disclosure may include a substrate 310 formed from a conductive metal material, a non-coated portion 312 where the substrate 310 is exposed, a coated portion 314 where an active material layer 314_1 is provided at ends of the substrate 310, and an electrode tab 320 that is bonded to the non-coated portion 312.

When the substrate 310 is a positive electrode substrate, the conductive metal material may include aluminum or an aluminum alloy. When the substrate 310 is a negative electrode substrate, the conductive metal material may include copper, a copper alloy, or nickel, a nickel alloy. The non-coated portion 312 of the electrode 300 for the secondary battery may be formed in the central portion of the substrate 310, and the coated portion 314 may be formed on both sides of the non-coated portion 312. However, the disposition or location of the non-coated portion 312 in the secondary battery electrode 300 is not limited to the depicted example, and the non-coated portion 312 may be formed on either terminal side of the substrate 310.

The electrode tab 320 may include a protrusion 322 protruding in the first direction D3 from a side of the non-coated portion 312. The protrusion 322 may electrically connect the secondary battery electrode 300 to another structure. The electrode tab 320 may include a notched portion 324 that is connected to the protrusion 322 and include a plurality of tabs 326 spaced apart from each other in a second direction D1 that is different from the first direction D3. The electrode tab 320 may be bonded to the non-coated portion 312, for example, by welding.

The notched portion 324 may be spaced apart from one side of the non-coated portion 312 in the first direction D3 by a certain gap. For example, the notched portion 324 may be spaced apart from one side of the non-coated portion 312 by a first gap S1 along the first direction D3. In specific examples, the first gap S1 may be equal to or less than 1 mm.

The notched portion 324 may be spaced apart from ends of the non-coated portion 312 in the second direction D1 by gaps. For example, the notched portion 324 may be spaced apart from ends of the non-coated portion 312 by a second gap S2 in the second direction D1. In specific examples, the second gap S2 may be 6 mm or more. By spacing the notched portion 324 apart from ends of the non-coated portion 312 by a certain gap or more in the second direction D1, it is possible to prevent a welding bead from being formed in the coated portion 314 when welding the electrode tab 320. In the illustrated embodiment, the notched portion 324 is illustrated as being spaced apart from each end of the non-coated portion 312 in the second direction D1 by the same distance> But the present disclosure this is not limited to this example and the notched portions 324 may be spaced apart by different distances.

In an embodiment, the first gap S1 may be less than the second gap S2. For example, the first gap S1 may be 1 mm or less, and the second gap S2 may be 6 mm or more. However, the present disclosure is not limited to this example, and electrode tabs 320 may be combined or disposed at various locations in consideration of the windability and electrical characteristics of the electrode 300 for the secondary battery.

The tabs 326 are disposed on the non-coated portion 312 and may be formed in a plurality along the second direction D1. In the illustrated embodiment, ten tabs 326 are formed by eight notches in the notched portion 324 with the tabs 326 being spaced from each other along the second direction D1.

The length of the protrusion 322 in the second direction D1 may be equal to the length of each of the plurality of tabs 326 in the second direction D1. However, the embodiment is not limited to this example, and the length of the protrusion 322 in the second direction D1 may be formed to various lengths.

The tabs 326 may electrically connect the secondary battery electrode 300 to another structure. When a plurality of tabs 326 are formed, each notching tab 326 may be formed with a certain gap along the second direction D1. Here, the gaps between neighboring tabs 326 may be greater than the lengths of the tabs 326 in the second direction D1. For example, the gap between neighboring tabs 326 may be 4 mm, and the length of each of the plurality of tabs 326 in the second direction D1 may be 1 mm to 2 mm. But the present disclosure is not limited to this example and gaps between and the lengths of the tabs 326 may vary depending on the size or purpose of the secondary battery electrode 300. By maintaining a gap between adjacent tabs 326 at a certain size or more, welding beads formed when welding the tabs 326 do not overlap.

In an embodiment, the length of each of the tabs 326 in the first direction D3 is less than half the length of the non-coated portion 312 in the first direction D3. When the lengths of the tabs 326 in the first direction D3 are greater than half of the length of the non-coated portion 312 in the first direction D3, cracks may form due to the pressure applied to the center of the secondary battery electrode 300 (i.e., the portion corresponding to half the length of the non-coated portion 312 in the first direction D3) when the secondary battery electrode 300 is wound. But cracks may be effectively prevented by limiting the length of the plurality of tabs 326 in the first direction D3.

In an embodiment, the protrusion 322 may be disposed at the center of the notched portion 324 along the second direction D1. However, the present disclosure is not limited to this example, and the protrusion 322 may be disposed or connected at any position of the notched portion 324 along the second direction D1.

By including an electrode tab 320 according to the configuration described above, variations of thickness of the electrode 300 for a secondary battery may be minimized,, which may prevent cracks that would otherwise occur during the charge/discharge process.

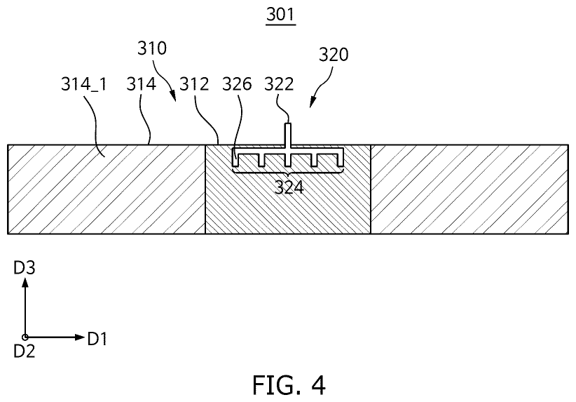

FIG. 4 is a view of an electrode 301 for a secondary battery according to embodiments of the present disclosure. The secondary battery electrode 301 illustrated in FIG. 4 may have the same or similar configuration as the first electrode 112 or second electrode 113 illustrated in FIG. 1. The electrode 301 may include a substrate 310 including a conductive metal material, a non-coated portion 312 where the substrate 310 is exposed, coated portions 314 where an active material layer 314_1 is provided at ends of the substrate 310, and an electrode tab 320 that is bonded to the non-coated portion 312.

When the substrate 310 is a positive electrode substrate, the conductive metal material may include aluminum or an aluminum alloy. When the substrate 310 is a negative electrode substrate, the conductive metal material may include copper, a copper alloy, or nickel, a nickel alloy. The non-coated portion 312 of the electrode 301 may be formed in the central portion of the substrate 310, and the coated portions 314 may be formed on both sides of the non-coated portion 312. However, the disposition or location of the non-coated portions 312 is not limited to this example and may be formed on either terminal side of the substrate 310.

The electrode tab 320 may include a protrusion 322 protruding in the first direction D3 from a side of the non-coated portion 312. The protrusion 322 may electrically connect the secondary battery electrode 301 to another structure. The electrode tab 320 may include a notched portion 324 that is connected to the protrusion 322, with the notched portion including a plurality of tabs 326 spaced apart from each other in a second direction D1 that is different from the first direction D3. The electrode tab 320 may be bonded to the non-coated portion 312, for example, by welding.

The tabs 326 are disposed on the non-coated portion 312 and may be formed in a plurality along the second direction D1. In the illustrated embodiment, five tabs 326 are formed by four notches. The notched portion 324 may be formed by disposing a plurality of tabs 326 along the second direction D1.

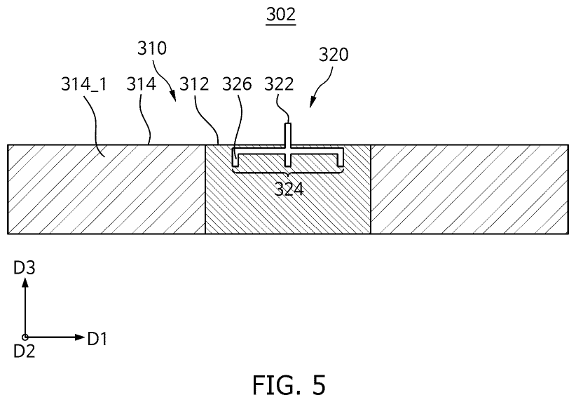

FIG. 5 is a view of an electrode 302 for a secondary battery according to embodiments of the present disclosure. The secondary battery electrode 302 illustrated in FIG. 5 may have the same or similar configuration as the first electrode 112 or second electrode 113 illustrated in FIG. 1. The electrode 302 may include a substrate 310 including a conductive metal material, a non-coated portion 312 where the substrate 310 is exposed, coated portions 314 where an active material layer 314_1 is provided at ends of the substrate 310, and an electrode tab 320 that is bonded to the non-coated portion 312.

When the substrate 310 is a positive electrode substrate, the conductive metal material may include aluminum or an aluminum alloy. When the substrate 310 is a negative electrode substrate, the conductive metal material may include copper, a copper alloy, or nickel, a nickel alloy. The non-coated portion 312 of the secondary battery electrode 302 may be formed in the central portion of the substrate 310, and the coated portions 314 may be formed on both sides of the non-coated portion 312. However, the disposition or location of the non-coated portion 312 in the secondary battery electrode 302 is not limited to this example and may be formed on either terminal side of the substrate 310.

The electrode tab 320 may include a protrusion 322 protruding in the first direction D3 from a side of the non-coated portion 312. The protrusion 322 may electrically connect the secondary battery electrode 302 to another structure. The electrode tab 320 may include a notched portion 324 that is connected to the protrusion 322 and includes a plurality of tabs 326 that are spaced apart from each other in a second direction D1 that is different from the first direction D3. The electrode tab 320 may be bonded to the non-coated portion 312, for example, by welding.

The tabs 326 are disposed on the non-coated portion 312 and may be formed in a plurality of numbers along the second direction D1. In the illustrated embodiment, three tabs 326 are formed by two notches in the notched portion 324. The notched portion 324 may be formed by disposing a plurality of tabs 326 along the second direction D1.

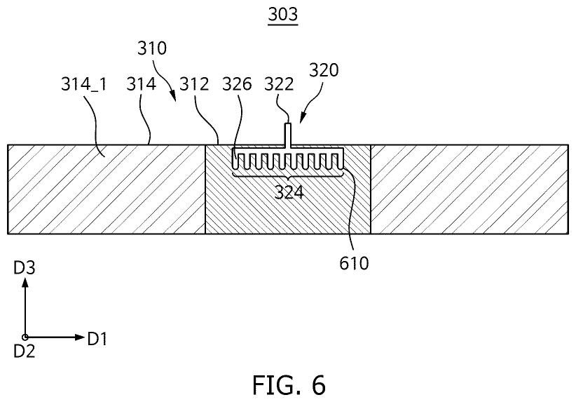

FIG. 6 is a view of an electrode 303 for a secondary battery according to embodiments of the present disclosure. The secondary battery electrode 303 illustrated in FIG. 6 may have the same or similar configuration as the first electrode 112 or second electrode 113 illustrated in FIG. 1. The electrode 303 may include a substrate 310 including a conductive metal material, a non-coated portion 312 where the substrate 310 is exposed, coated portions 314 where an active material layer 314_1 is provided at ends of the substrate 310, and an electrode tab 320 that is bonded to the non-coated portion 312.

When the substrate 310 is a positive electrode substrate, the conductive metal material may include aluminum or an aluminum alloy. When the substrate 310 is a negative electrode substrate, the conductive metal material may include copper, a copper alloy, or nickel, a nickel alloy. The non-coated portion 312 of the secondary battery electrode 303 may be formed in the central portion of the substrate 310, and the coated portions 314 may be formed on sides of the non-coated portion 312. However, the disposition or location of the non-coated portions 312 in the secondary battery electrode 303 is not limited to the depicted example and may be formed on either terminal side of the substrate 310.

The electrode tab 320 may include a protrusion 322 protruding in the first direction D3 from a side of the non-coated portion 312. The protrusion 322 may electrically connect the secondary battery electrode 303 to another structure. The electrode tab 320 may include a notched portion 324 that connected to the protrusion 322 and includes a plurality of tabs 326 spaced apart from each other in a second direction D1 that is different from the first direction D3. The electrode tab 320 may be bonded to the non-coated portion 312, for example, by welding.

The tabs 326 disposed on the non-coated portion 312 may be formed in a plurality along the second direction D1. For example, in the illustrated embodiment, ten tabs 326 are formed by eight notches in the notched portion 324 in the second direction D1.

In an embodiment, an end 610 of at least one of the plurality of tabs 326 may be circular shaped. If the end 610 of the notching tab 326 has a polygonal shape such as a quadrangle, stress may be concentrated at the vertex of the end 610 when the secondary battery electrode 303 is would, for example, into a jelly-roll shape. But when the end 610 of the notching tab 326 has a circular shape, the mechanical stability of the secondary battery electrode 303 is improved during winding. However, the present disclosure is not limited to this example, and the end 610 of the electrode tab 320 may have various shapes.

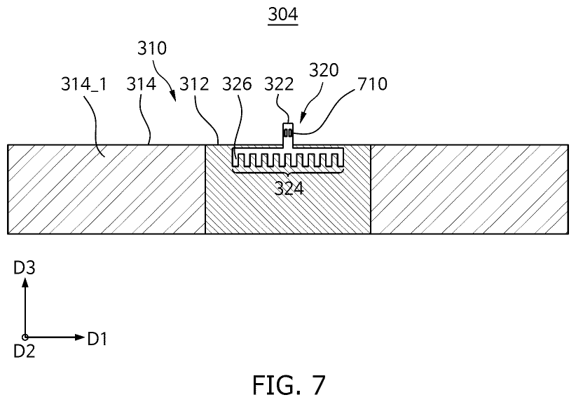

FIG. 7 is a view of an electrode 304 for a secondary battery according to embodiments of the present disclosure. The secondary battery electrode 304 illustrated in FIG. 7 may have the same or similar configuration as the first electrode 112 or second electrode 113 illustrated in FIG. 1. The electrode 304 for a secondary battery according to some embodiments of the present disclosure may include a substrate 310 including a conductive metal material, a non-coated portion 312 where the substrate 310 is exposed, coated portions 314 where an active material layer 314_1 is applied to ends of the substrate 310, and an electrode tab 320 that is bonded to the non-coated portion 312.

When the substrate 310 is a positive electrode substrate, the conductive metal material may include aluminum or an aluminum alloy. When the substrate 310 is a negative electrode substrate, the conductive metal material may include copper, a copper alloy, or nickel, a nickel alloy. In an embodiment, the non-coated portion 312 of the secondary battery electrode 304 may be formed in the central portion of the substrate 310, and the coated portions 314 may be formed on sides of the non-coated portion 312. However, the disposition or location of the non-coated portion 312 in the secondary battery electrode 304 is not limited to this example and may be formed on either terminal side of the substrate 310.

The electrode tab 320 protrudes from a side of the non-coated portion 312 in the first direction D3 and may include a protrusion 322 that includes at least one through hole 710. The protrusion 322 may electrically connect the secondary battery electrode 304 to another structure. The at least one through hole 710 may be formed a certain distance from the non-coated portion 312 of the substrate 310. The shape of at least one through hole 710 may be a quadrangle. By forming at least one through hole 710, the electrode tab 320 rupture at a lower temperature, for example, during a short circuit event. Accordingly, the electrode 304 is made safer.

The electrode tab 320 may include a notched portion 324 that is connected to the protrusion 322 and includes a plurality of tabs 326 spaced apart from each other in a second direction D1 that is different from the first direction D3. The electrode tab 320 may be bonded to the non-coated portion 312, for example, by welding.

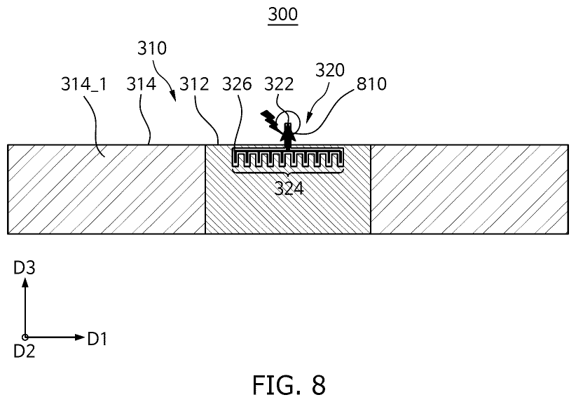

FIG. 8 shows a mechanism by which an electrode tab 320 of a secondary battery electrode 300 ruptures at a low temperature. Referring to FIG. 8, current 810 may flow from the tabs 326 to the protrusion 322. Here, the length of the protrusion 322 in the second direction D1 may be equal to the length of each of the tabs 326 of the notched portion 324 in the second direction D1. Accordingly, because the current 810 flowing through each of the tabs 326 is concentrated and flows to the protrusion 322, a relatively large resistance may be formed in the protrusion 322. As a large resistance is formed in the protrusion 322, the current and/or temperature at which the electrode tab 320 ruptures may become lower. That is, by designing the electrode tab 320 to have a relatively higher resistance than the tabs 326 at the portion where it is electrically connected to an outside structure, the electrode tab 320 may more easily break when a specific event occurs. Accordingly, it is possible to prevent side reactions and thermal runaway from occurring due to overcurrent inside a secondary battery (e.g., secondary battery 100 of FIG. 1). And the electrical safety of the electrode 300 for a secondary battery may be improved. In the embodiment depicted in FIG. 8, a mechanism in which the electrode tab 320 of the secondary battery electrode 300 of FIG. 3 is ruptured at a low temperature is disclosed, but the present disclosure is not limited to this example, and the same mechanism may be applied to various embodiments of the secondary battery electrodes 300 to 304 disclosed in FIGS. 3 to 7.

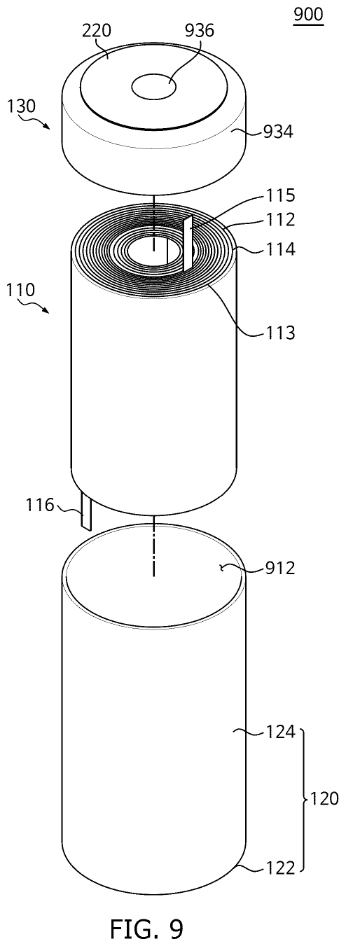

FIG. 9 is an exploded perspective view of a secondary battery 900 including an electrode for a secondary battery according to an embodiment of the present disclosure. The secondary battery 900 disclosed in FIG. 9 may correspond to the secondary battery 100 disclosed in FIG. 1. Referring to FIG. 9, a secondary battery 900 may include a case 120, an electrode assembly 110, and a cap assembly 130. The case 120 may include a bottom portion 122, a side wall portion 124 connected to the bottom portion 122, and an upper opening 912 facing the bottom portion 122. The case 120 may accommodate an electrode assembly 110. Here, “upper” in the term “upper opening” 912 may mean an end where the cap assembly 130 is disposed in the longitudinal direction of the secondary battery 900. Similarly, a bottom may mean an opposite end of the upper end in the longitudinal direction of the secondary battery 900.

According to embodiments of the present disclosure, the case 120 may be formed integrally with the bottom portion 122 and the side wall portion 124. As such, a separate process for joining the bottom portion 122 with the side wall portion 124, which are separated from each other, in the secondary battery according to the present disclosure is not required. According to some embodiments of the present disclosure, the case 120 may be a cylindrical case.

The electrode assembly 110 may include a first electrode 112 and a second electrode 113. The first electrode 112 may be a positive electrode and the second electrode 113 may be a negative electrode. The first electrode 112 may be formed at the top of the electrode assembly 110, and the second electrode 113 may be formed at the bottom of the electrode assembly 110. Of course, the opposite is also possible. Alternatively, both the first electrode 112 and the second electrode 113 may be formed on the top of the electrode assembly 110.

The cap assembly 130 may include an upper cap 220, an insulating member 934, and an electrolyte solution injection port 936. The upper cap 220 may be electrically connected to the first electrode 112 of the electrode assembly 110.

The first electrode 112 of the electrode assembly 110 may be electrically connected to the cap assembly 130. However, the present disclosure is not limited to this example, and the second electrode 113 of the electrode assembly 110 may be electrically connected to the case 120.

The insulating member 934 insulates the area between the upper cap 220 and the case 120. In one example, the insulating member 934 may be formed to surround the upper cap 220. But the present disclosure is not limited to this example, and various shapes may be used as long as they insulate between the upper cap 220 and the case 120.

The electrolyte solution injection port 936 may be formed to penetrate the cap assembly 130. More specifically, the electrolyte solution injection port 936 may be formed to penetrate the upper cap 220. Electrolyte solution is injected into the secondary battery 900 through the electrolyte solution injection port 936, and gas generated inside the secondary battery 900 may be discharged through the port 936.

The secondary battery 900 may be a lithium secondary battery of a sodium secondary battery. However, the scope of the present disclosure is not limited to these examples, and the secondary battery 900 may be other types of battery that repeatedly provide electricity by charging and discharging.

According to some embodiments of the present disclosure, the electrode assembly 110 may be formed by alternately stacking the first electrode 112 and the second electrode 113 with the separator 114 and then winding the combined structure. The first electrode 112 and/or the second electrode 113 may correspond to the electrodes 300 to 304 for secondary batteries disclosed in FIGS. 3 to 7 and described above.

Although the present disclosure has been described with reference to embodiments and drawings illustrating aspects thereof, the present disclosure is not limited thereto. Various modifications and variations can be made by a person skilled in the art to which the present disclosure belongs within the scope of the technical spirit of the present disclosure.

1. An electrode for a secondary battery, the electrode comprising:
a substrate comprising a conductive metal material;
a non-coated portion where the substrate is exposed;
coated portions at ends of the substrate where an active material layer is provided; and
an electrode tab coupled to the non-coated portion,
wherein the electrode tab comprises:
a protrusion protruding in a first direction from aside of the non-coated portion; and
a notched portion comprising a plurality of tabs connected to the non-coated portion and spaced apart from each other in a second direction that is different from the first direction.

2. The electrode as claimed in claim 1, wherein the notched portion is spaced apart from ends of the non-coated portion by gaps in the second direction.

3. The electrode as claimed in claim 1, wherein the notched portion is spaced apart from a side of the non-coated portion in the first direction by a gap.

4. The electrode as claimed in claim 1, wherein the notched portion is spaced apart from a side of the non-coated portion by a first gap in the first direction,
wherein the notched portion is spaced apart from ends of the non-coated portions by a second gap in the second direction, and
wherein the first gap is less than the second gap.

5. The electrode as claimed in claim 1, wherein a gap between adjacent tabs among the plurality of tabs is greater than a length of each of the tabs in the second direction.

6. The electrode as claimed in claim 1, wherein each of the tabs has a length in the first direction that is less than half of a length of the non-coated portion in the first direction.

7. The electrode as claimed in claim 1, wherein each of the tabs extends in the first direction.

8. The electrode as claimed in claim 7, wherein the protrusion is disposed at a central portion of the notched portion along the second direction.

9. The electrode as claimed in claim 1, wherein an end of at least one of the tabs includes a circular shape.

10. The electrode as claimed in claim 1, wherein at least one hole extends through the protrusion,, with the hole being spaced apart from the non-coated portion.

11. A secondary battery comprising:
an electrode assembly comprising a first electrode, a second electrode, and a separator disposed between the first electrode and the second electrode;
a case comprising a bottom portion electrically connected to the second electrode, a side wall portion connected to the bottom portion, and an opening on an upper side facing the bottom portion, with the case accommodating the electrode assembly; and
a cap assembly coupled to the case to close opening,
wherein the first electrode comprises:
a substrate comprising a conductive metal material;
a non-coated portion where the substrate is exposed;
coated portions at ends of the substrate where an active material layer is provided; and
an electrode tab coupled to the non-coated portion,
wherein the electrode tab comprises:
a protrusion protruding in a first direction from a side of the non-coated portion; and
a notched portion comprising a plurality of tabs connected to the non-coated portion and spaced apart from each other in a second direction that is different from the first direction.

12. The secondary battery as claimed in claim 11, wherein the notched portion is spaced apart from ends of the non-coated portion by gaps in the second direction.

13. The secondary battery as claimed in claim 11, wherein the notched portion is spaced apart from a side of the non-coated portion in the first direction by a gap.

14. The secondary battery as claimed in claim 11, wherein the notched portion is spaced apart from a side of the non-coated portion by a first gap in the first direction,
wherein the notched portion is spaced apart from ends of the non-coated portion by a second gap in the second direction, and
wherein the first gap is less than the second gap.

15. The secondary battery as claimed in claim 11, wherein a gap between adjacent tabs among the plurality of tabs is greater than a length of each of the in the second direction.

16. The secondary battery as claimed in claim 11, wherein each of the tabs has a length in the first direction that is less than half of a length of the non-coated portion in the first direction.

17. The secondary battery as claimed in claim 11, wherein each of the tabs extends in the first direction.

18. The secondary battery as claimed in claim 17, wherein the protrusion is disposed at a central portion of the notched portion along the second direction.

19. The secondary battery as claimed in claim 11, wherein an end of at least one of the tabs has a circular shape.

20. The secondary battery as claimed in claim 11, wherein at least one hole extends through the protrusion and with the hole spaced from the non-coated portion.
